(19) United States
(12) Patent Application Publication
(10) Pub. No.: US 2025/0274619 A1
(43) Pub. Date: Aug. 28, 2025

(54) IP AUGMENTED TELEVISION STREAMS

(71) Applicant: DISH Network L.L.C., Englewood, CO (US)

(72) Inventors: Samuel Eber, Denver, CO (US); Robert Sadler, Denver, CO (US)

(21) Appl. No.: 19/061,514

(22) Filed: Feb. 24, 2025

Related U.S. Application Data
(60) Provisional application No. 63/556,689, filed on Feb. 22, 2024.

(51) Int. Cl. H04N 21/2343; H04N 21/2187; H04N 21/239; H04N 21/61

(52) U.S. Cl. CPC H04N 21/2343; H04N 21/2187; H04N 21/2393; H04N 21/6125

(57) ABSTRACT

Techniques for augmenting IP television streams are presented herein. In some techniques, an original video stream is encoded as a compressed video stream by a satellite television system and broadcast via a satellite television network. The lost data resulting from encoding the original video stream as the compressed video stream is encoded as an augmentation video stream and transmitted to a remote device via the Internet in response to a request from the remote device received by the satellite television system via the Internet to enhance the compressed video stream with the augmentation video stream.

### CROSS REFERENCE TO RELATED APPLICATIONS

This application claims priority to U.S. Provisional Patent Application No. 63/556,689, filed on Feb. 22, 2024, the disclosure of which is incorporated by reference in its entirety for all purposes.

### BACKGROUND OF THE INVENTION

As the ability to capture and display higher quality video content continues to improve, there are numerous technical challenges conventional broadcast television networks must face to keep up. Due to the available bandwidth and throughput of the physical channels used to broadcast an ever increasing number of channels and content, the quality is often sacrificed in favor quantity. While Internet based solutions have developed various techniques for delivering high quality video content, there is a need for systems, methods, and processor readable media that address the foregoing challenges associated with providing high quality video content via a broadcast television network.

### BRIEF SUMMARY OF THE INVENTION

Various embodiments are described related to Internet Protocol (IP) augmented television streams. In some embodiments, a method of augmenting satellite television streams is described. The method may comprise receiving, by a satellite television server system, an original video stream. The method may further comprise encoding, by the satellite television server system, the original video stream as a compressed video stream. Encoding the original video stream may result in lost data from the original video stream. The method may further comprise encoding, by the satellite television server system, the lost data from the original video stream as an augmentation video stream. The method may further comprise broadcasting, by the satellite television server system, the compressed video stream via a satellite television network. The method may further comprise receiving, by the satellite television server system, a request from a remote device via the Internet to enhance the compressed video stream with the augmentation video stream. The method may further comprise transmitting, by the satellite television server system, and in response to the request, the augmentation video stream to the remote device via the Internet.

In some embodiments, the augmentation video stream is further encoded with synchronization data that can be used to synchronize the augmentation video stream with the compressed video stream. In some embodiments, the synchronization data comprises a time delay estimate between when the remote device will receive the augmentation video stream and when the remote device will receive the compressed video stream. In some embodiments, the compressed video stream is broadcast on a delay compared to the transmission of the augmentation video stream, and the time delay estimate is based on the delay between the compressed video stream broadcast and the augmentation video stream transmission. In some embodiments, the augmentation video stream comprises a stream of reconstruction packets, the compressed video stream comprises a stream of frames, and the synchronization data for each reconstruction packet comprises a timestamp representing an estimated time when a frame that corresponds to the reconstruction packet will be received by the remote device.

In some embodiments, the augmentation video stream comprises a stream of reconstruction packets, the compressed video stream comprises a stream of compressed video frames, and each reconstruction packet corresponds to two or more sequential compressed video frames. In some embodiments, encoding the lost data from the original video stream comprises: determining, for successive sets of two or more compressed video frames, a loss factor from which at least a portion of the lost data for each of the two or more compressed video frames can be reconstructed when the loss factor is decoded; and encoding, for each successive set of two or more compressed video frames, the loss factor in a corresponding reconstruction packet.

In some embodiments, each successive set of two or more compressed video frames overlap with a preceding set and a succeeding set by at least one compressed video frame. In some embodiments, each successive set of two or more compressed video frames are contiguous with a preceding set and a succeeding set. In some embodiments, wherein encoding the original video stream as the compressed video stream comprises applying one or more compression parameters to each original video frame of the original video stream, and the loss factor for each successive set of two or more compressed video frames is based at least in part on the one or more compression parameters applied to the corresponding original video frames. In some embodiments, the loss factor for each successive set of two or more compressed video frames is based on similar lost data in each of the two or more compressed video frames.

In some embodiments, a television receiver is described. The television receiver may comprise: a broadcast television interface that receives a plurality of television channels from a dedicated television network; a network interface that accesses the Internet; one or more processors; and a non-transitory computer readable storage medium storing instructions which, when executed by the one or more processors, cause the one or more processors to: receive a request to provide live media content from a first television channel of the plurality of television channels to a display device for presentation. The instructions may further cause the one or more processors to transmit, via the network interface, a request for an augmentation video stream associated with the first television channel to a remote television server system. The instructions may further cause the one or more processors to receive, via the network interface, and from the remote television server system, the augmentation video stream associated with the first television channel. The instructions may further cause the one or more processors to receive, via the broadcast television interface, a compressed video stream representing the live media content from the first television channel. The instructions may further cause the one or more processors to decode the compressed video stream into a reconstructed video stream of the live media content. The instructions may further cause the one or more processors to decode the augmentation video stream into a lost data stream that represents lost data from an original stream of the live media content that is not included in the reconstructed video stream. The instructions may further cause the one or more processors to combine the reconstructed video stream with the lost data stream to produce an enhanced quality video stream. The instructions may further cause the one or more processors to provide the enhanced quality video stream to the display device for presentation.

### BRIEF DESCRIPTION OF THE DRAWINGS

FIG. 1 illustrates an embodiment of an IP augmented satellite television content delivery system.

FIG. 2 illustrates an embodiment of an IP augmented television server system within an IP augmented television content delivery system.

FIG. 3 illustrates exemplary streams generated by an IP augmented television server system.

FIG. 4 illustrates an embodiment of an IP augmented television receiver within an IP augmented television content delivery system.

FIG. 5 illustrates an embodiment of a method for generating IP augmented television streams.

FIG. 6 illustrates an embodiment of a method for displaying IP augmented television streams.

### DETAILED DESCRIPTION OF THE INVENTION

Various embodiments according to the present disclosure may provide for Internet Protocol (IP) augmented television streams. Television service providers, such as satellite or cable television providers, rely on dedicated networks to broadcast live media content across wide geographic areas. However, while these networks have benefited from various improvements that allow them to transmit more data in the same amount of time, there are still limits to the amount of data that can be broadcast over these networks at the same time. As a result, the content delivered via these dedicated networks is often of a lower quality than is otherwise available.

Embodiments described herein address these and other technological challenges by providing a supplemental stream of data over the Internet that can be used to enhance the quality of video content received over a dedicated television network. Further, embodiments described herein may do so with minimal modifications to the existing infrastructure used to broadcast the lower quality video content while avoiding excessive data transmission associated with transmitting duplicate data.

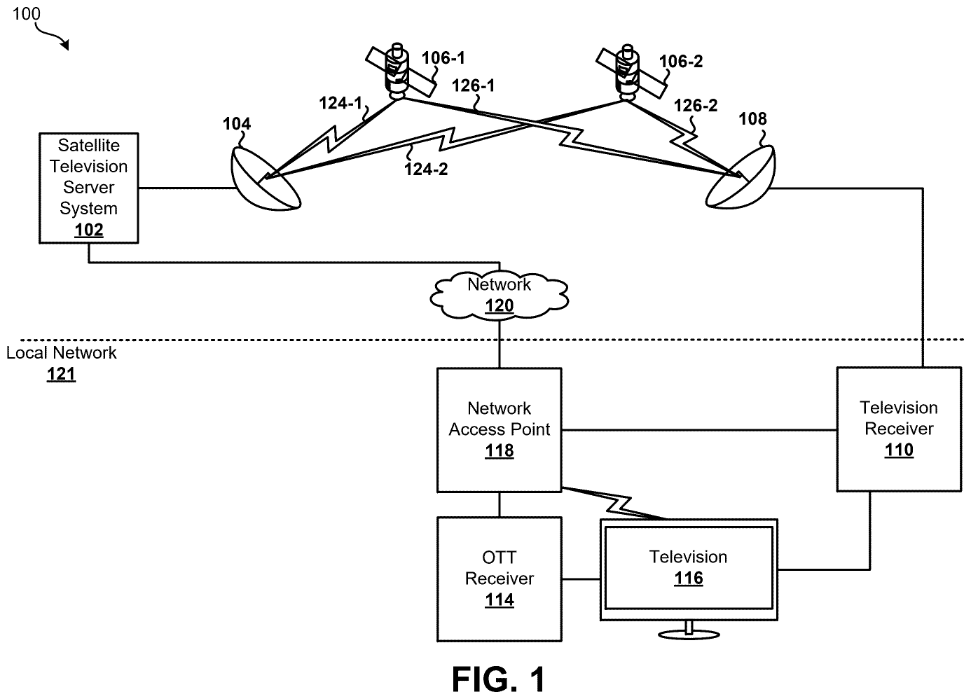

Further detail regarding IP augmented television streams is provided in relation to the figures. FIG. 1 illustrates an embodiment of an satellite television content delivery system. For brevity, system 100 is depicted in a simplified and conceptual form and may generally include more or fewer systems, devices, networks, and/or other components as desired. Further, the number and type of features or elements incorporated within system 100 may or may not be implementation-specific, and at least some of the aspects of system 100 may be similar to a cable television distribution system, an IPTV (Internet Protocol Television) content distribution system, and/or any other type of media or content distribution system.

System 100 may also include at least one network 120 that may facilitate bi-directional communication for data transfer between devices connected to network access point 118 and satellite television server system 102. Network 120 is intended to represent any number of terrestrial and/or non-terrestrial network features or elements. For example, network 120 may incorporate or exhibit any number of features or elements of various wireless and/or hardwired packet-based communication networks such as, for example, a WAN (Wide Area Network) network, a HAN (Home Area Network) network, a LAN (Local Area Network) network, a WLAN (Wireless Local Area Network) network, the Internet, a cellular network, or any other type of communication network within which data may be transferred between and among respective components of the system 100. System 100 may also include at least one local network 121 that establishes a bi-directional communication path for data transfer between devices in a local environment, such as network access point 118, television receiver 110, OTT receiver 114, and/or television 116. Local network 121 may correspond to a home or business computing environment. Television receiver 110, OTT receiver 114, network access point 118, and television 116, may each be incorporated within or form at least a portion of a particular home or business computing network.

Television receiver 110 and OTT receiver 114 may correspond to a television receiver and/or television converter, such as a set-top box (STB) for example. In another example, television receiver 110 and OTT receiver 114 may exhibit functionality integrated as part of or into a television; a DVR (Digital Video Recorder); a computer, such as a tablet computing device; or any other computing system or device, as well as variations thereof. Further, television receiver 110 may be able to communicate with other devices in accordance with various communication protocol(s) and/or standard(s) including, for example, TCP/IP (Transmission Control Protocol/Internet Protocol), DLNA/DTCP-IP (Digital Living Network Alliance/Digital Transmission Copy Protection over Internet Protocol), HDMI/HDCP (High-Definition Multimedia Interface/High-bandwidth Digital Content Protection). For example, as disclosed further herein, one or more of the various elements or components of the at least one local network 121 may communicate using TCP/IP using one or more wireless techniques, such as Wi-Fi; or wired techniques, such as Ethernet or MoCA® (Multimedia over Coax Alliance). Still other embodiments are possible.

In practice, satellites 106 may each receive uplink signals 124 from satellite uplink 104. In this example, each of uplink signals 124 may contain one or more transponder streams of particular data or content, such as one or more particular television channels, as supplied by satellite television server system 102. For example, each of the respective uplink signals 124 may contain various media content such as encoded HD (High Definition) television channels, SD (Standard Definition) television channels, regional broadcast channels from local providers, on-demand programming, programming information, and/or any other content in the form of at least one transponder stream, in accordance with an allotted carrier frequency and bandwidth. In this example, different media content may be carried using different versions of satellites 106.

Satellites 106 may further relay uplink signals 124 to satellite dish 108 as downlink signals 126. Similar to uplink signals 124, each of downlink signals 126 may contain one or more transponder streams of particular data or content, such as various encoded and/or at least partially electronically scrambled television channels and/or on-demand programming, in accordance with an allotted carrier frequency and bandwidth. Downlink signals 126, however, may not necessarily contain the same or similar content as a corresponding one of uplink signals 124. For example, uplink signal 124-1 may include a first transponder stream containing at least a first group or grouping of television channels, and downlink signal 126-1 may include a second transponder stream containing at least a second, different group or grouping of television channels. In other examples, the first and second group of television channels may have one or more television channels in common. In sum, there may be varying degrees of correlation between uplink signals 124 and downlink signals 126, both in terms of content and underlying characteristics. Satellite signals may include multiplexed, packetized, and modulated digital signals. Once multiplexed, packetized and modulated, one analog satellite transmission may carry digital data representing several television stations or service providers. Some examples of service providers include HBO®, CBS®, and/or ESPN®.

In some embodiments, downlink signals 126 contain one or more compressed video streams corresponding to live or pre-recorded media content. The live or pre-recorded media content may be compressed and encoded from original video streams into the compressed video streams. For example, satellite television server system 102 may receive the original video streams from one or more content producers or distributors. Satellite television server system 102 may then compress and encode the original video streams to meet bandwidth and data transmission constraints associated with satellite uplink 104 and/or satellites 106. As such, the encoding and compression process may result in a loss of quality from the original video streams when the compressed video streams are decompressed and decoded for display.

In some embodiments, satellite television server system 102 supplements the resulting loss in the compressed video streams with an augmentation or enhancement stream. As described further below, the augmentation or enhancement stream may represent a stream of data which, when combined with the uncompressed data from the compressed video stream, will result in enhanced video quality compared to the video quality associated with the compressed video stream alone. To overcome the data transmission constraints associated with the broadcast satellite television network, the augmentation streams may be provided to television receivers, such as television receiver 110, via a separate communication network, such as network 120. Once received, television receiver 110 may then synchronize the two streams and combine their data to produce an enhanced video quality for display on television 116.

Satellite dish 108 may be provided to receive television channels (e.g., on a subscription basis) provided by satellite television server system 102, satellite uplink 104, and/or satellites 106. For example, satellite dish 108 may receive particular transponder streams, or downlink signals 126, from one or more of satellites 106. As another example, satellite dish 108 may provide a plurality of television channel frequencies to a television frequency tuner of television receiver 110. Additionally, television receiver 110, which is communicatively coupled to satellite dish 108, may subsequently select via a tuner, decode, and relay particular transponder streams to television 116 for display thereon. For example, satellite dish 108 and television receiver 110 may, respectively, receive, decode, and relay at least one television channel to television 116. As another example, television receiver 110 may tune a television frequency tuner to a television channel frequency of a plurality of television channel frequencies received by satellite dish 108. Programming or content associated with the channel may generally be presented live, or from a recording as previously stored on, by, or at television receiver 110. Here, the channel may be output to television 116 in accordance with the HDMI/HDCP content protection technologies. However, other embodiments are possible. For example, the channel may be output to television 116 in accordance with the MoCA® (Multimedia over Coax Alliance) home entertainment networking standard. As another example, the channel may be output to television 116 in accordance with the Transmission Control Protocol (TCP) and/or Internet Protocol (IP) via network access point 118 over local network 121.

Further, television receiver 110 may select via a tuner, decode, and relay particular transponder streams to OTT receiver 114 which may in turn relay particular transponder streams to television 116 for display thereon. For example, satellite dish 108 and television receiver 110 may, respectively, receive, decode, and relay at least one television channel to television 116 by way of OTT television receiver 114. Additionally, or alternatively, television receiver 110 may select via a tuner, decode, and relay particular transponder streams directly to television 116 for display thereon. Similar to the above-example, television channels may be presented live, or from a recording as previously stored on television receiver 110, and may be output to television 116 by way of OTT television receiver 114 in accordance with a particular content protection technology and/or networking standard.

Relaying transponder streams and/or digital content from television receiver 110 to televisions 116 via OTT receiver 114 may include transmission via wireless communication. For example, the at least one local network 121 may include a private content network. Television receiver 110 may then transmit digital content to OTT receiver 114 via the private content network. Additionally, or alternatively, relaying transponder streams and/or digital content from television receiver 110 to televisions 116 via OTT receiver 114 may include transmission via one or more wired connections. For example, television receiver 110 may be connected to OTT receiver 114 and/or television 116 via a networking cable, such as CAT-5, a coaxial cable, a universal serial bus (USB) cable, and the like.

OTT receiver 114 and television 116 may receive digital content from OTT providers via network 120. For example, while television receiver 110 may receive satellite television channels via satellite dish 108 and provide them to OTT receiver 114, OTT receiver 114 may also access network 120 via network access point 118, as described below, to stream digital content from OTT providers, such as Netflix®, Spotify®, Google®, YouTube®, Disney®, Hulu®, Peacock®, etc. and relay the digital content to television 116 for display thereon. While described as streaming content, OTT receiver 114 may also transmit, receive, or otherwise have access to, other forms of data such as documents, databases, websites, email, search engine results, digital assistant interfaces, and the like.

Network access point 118 may function similar to a wireless router. For example, network access point 118 may receive digital communication from television receiver 110 and route the digital communication to an intended recipient of OTT receiver 114, television 116, other devices on local network 121, and/or remote server systems, such as satellite television server system 102, over network 120. Network access point 118 may receive the digital communication via a wired connection from television receiver 110, such as via an Ethernet or MoCA® connection. Network access point 118 may then transmit the digital communication to the appropriate recipient via a wireless communication standard, such as Wi-Fi, Bluetooth®, ZigBee®, or the like. Additionally, network access point 118 may receive communication from any of OTT receiver 114, television 116, other devices on local network 121, and/or satellite television server system 102 and relay the communication to television receiver 110 via a wired or wireless connection.

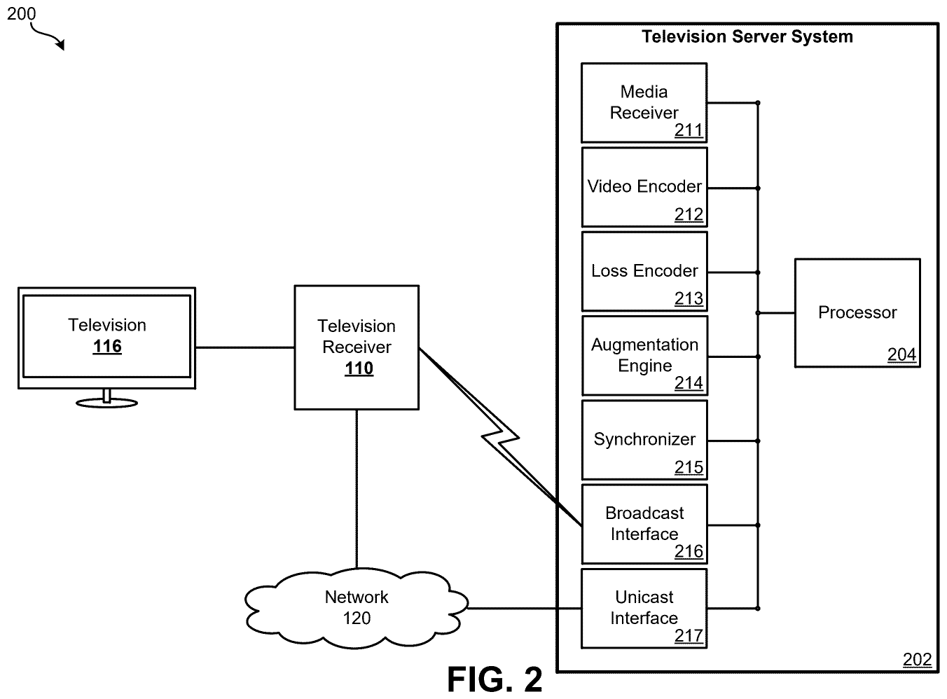

FIG. 2 illustrates an embodiment of an IP augmented television server system within a television content delivery system 200. Television content delivery system 200 can include television server system 202, television receiver 110, and television 116. Network 120 may function as described above. For example, network 120 may facilitate bi-directional communication between television receiver 110 and television server system 202. Additionally, or alternatively, television receiver 110 may receive broadcast television content from television server system 202. For example, as described above, primary television receiver 110 may be coupled with a satellite antenna configured to receive data broadcasted through one or more satellites by television server system 202. As another example, primary television receiver 110 may receive media content broadcasted through a cable network from television server system 202. In some embodiments, the television server system 202 may also enhance the compressed stream and deliver the fully augmented/reconstructed stream to a television receiver, OTT device, and/or an application on the TV.

As described above in relation to satellite television server system 102, television server system 202 may include one or more remote services configured to provide digital content such as live television channels, subscription television shows, streaming movies, streaming audio, shopping, etc. to a requesting device, such as television receiver 110. In some implementations, television server system 202 may include a plurality of services such as: media receiver 211; video encoder 212; loss encoder 213; augmentation engine 214; synchronizer 215; broadcast interface 216; and unicast interface 217. One or more of the services of television server system 202 may be implemented as standalone and/or integrated software applications stored in a memory of television server system 202. Additionally, or alternatively, one or more of the services may be implemented in hardware as a special-purpose computer or embedded system. Television server system 202 may also include processor 204 and one or more databases.

Processor 204 may be a processor or processing apparatus (e.g., a server) configured to execute executable code that performs the various functions provided by the plurality of services of television server system 202, according to implementations described herein. The executable code may be stored in a memory (not shown) associated with processor 204.

Media receiver 211 may receive live or prerecorded media content from one or more content distributors, such as network television channels, movie channels, movie studios, or the like. The live or prerecorded media content may be received as original, or uncompressed, video streams and/or video files. In some embodiments, media receiver 211 stores the original video streams and/or video files in a local media library or database for subsequent access. For example, media receiver 211 may store portions of original live video streams as individual episodes or shows for subsequent video-on-demand requests. After processing a live video stream, and/or in response to a request for a recording stored in a media library, media receiver 211 may provide the video stream, and/or stream recorded media content, to video encoder 212 and/or loss encoder 213.

Video encoder 212 may receive live or prerecorded video streams from media receiver 211 and encode the video streams for broadcast transmission over a dedicated television content delivery network, such as a satellite or cable television network. As further described above, video encoder 212 may apply one or more compression algorithms to the original video streams to meet data transmission constraints associated with the dedicated television content delivery network. The compression algorithms may adhere to one or more predefined standards, protocols, and/or profiles such as the Moving Picture Experts Group-4 (MPEG-4) standard, H.264, Advanced Video Coding (AVC), High Efficiency Video Coding (HEVC/H.265), DivX, Xvid, or the like.

The resulting compressed video stream may therefore have an inherent loss when decoded to reconstruct the original video stream. For example, the compressed video stream may lose high-frequency details in the original video, such as fine textures, intricate patterns, and sharp edges can be lost or blurred. These losses may be due to the quantization of high-frequency components in the Discrete Cosine Transform (DCT) process. Another example may include lost color fidelity, such as color distortions or reduced color accuracy in areas with subtle color variations. This may be as a result of chrominance (color) components being more heavily compressed than luminance (brightness) components. Additional losses may result in blocky artifacts, edge distortions, temporal artifacts, quantization noise, loss of fine gradients, text and graphic degradation, loss of subtle facial expressions, and/or texture and pattern losses. The extent of the losses can vary depending on the compression settings, bitrate, and the specific content being compressed.

In some embodiments, video encoder 212 provides the compressed video stream to broadcast interface 216 for transmission as the original video stream is encoded and compressed. Additionally, or alternatively, video encoder 212 may provide some combination or subtraction of the original video stream and the compressed video stream to loss encoder 213. For example, during or after compression, video encoder 212 may identify some or all of the losses from the original video stream and provide a stream of the losses to loss encoder 213. As another example, video encoder 212 may use one or more Scalable Video Coding (SVC) standards or protocols to encode the original video stream into a base layer representing the lowest quality layer and one or more enhancement layers that can be used to improve the quality of the base layer. Subsequently, video encoder 212 may provide the base layer to broadcast interface 216 as the compressed video stream and the one or more enhancement layers to loss encoder 213. Additionally, or alternatively, video encoder 212 may provide the compressed video stream to loss encoder 213 to identify the losses.

Loss encoder 213 may generate an augmentation stream representing the losses in the compressed video stream generated by video encoder 212. As described above, loss encoder 213 may generate the augmentation stream from the original video stream, the compressed video stream, or another stream of data, such as an enhancement layer stream created with the compressed video stream. The augmentation stream may be used as an enhancement layer to improve the quality of the resulting video when the compressed video stream is decoded and decompressed.

In some embodiments, the relationship between the data in the augmentation stream and the data in the compressed video stream is a one-to-many relationship. In other words, data encoded in the augmentation stream is applicable to multiple video frames in the compressed video stream. For example, the augmentation stream may include a stream of Short-Term Reference (STR) frames, Long-Term Reference (LTR) frames, or the like. Each reference frame may refer to two or more frames in the compressed video stream and include information that can be used to enhance the quality each video frame. For example, the information may include additional details for similar visual features depicted in each video frame, such as a background or stationary object in each of the frames. Additionally, or alternatively, the augmentation stream may include one or more compression parameters used to generate different groups of video frames in the compressed video stream. During decompression, the compression parameters may then be used to infer or predict the losses from the original video stream.

In some embodiments, using a one-to-many relationship between the augmentation stream and the compressed video stream helps overcome various technical challenges associated with separately transmitting the compressed video stream and the augmentation stream via different communication networks (e.g., a broadcast television network and the Internet). For example, due to the different propagation times for the broadcast television network and the Internet, the compressed video stream and the augmentation stream may arrive at television receiver 110 asynchronously. By making data in the augmentation stream generally applicable to groups of video frames in the compressed video stream, television receiver 110 may combine both streams as they are received in real-time without needing to synchronize or buffer either stream. Additionally, or alternatively, using a one-to-many relationship may reduce an amount of buffering required by television receiver 110 when the augmentation stream is transmitted in advance of the compressed video stream.

Augmentation engine 214 may coordinate the transmission of the augmentation streams to television receiver 110. While dedicated television networks may enable television server system 202 to broadcast every available compressed video stream at the same time via broadcast interface 216, broadcasting every available augmentation stream over the Internet to every connected television receiver would be inefficient, if not impossible. Accordingly, augmentation engine 214 may direct individual augmentation streams to a requesting device. For example, in response to receiving a channel tuning request from television receiver 110 over network 120, augmentation engine 214 may identify an augmentation stream generated by loss encoder 214 that corresponds to the requested television channel and begin streaming the augmentation stream to television receiver 110 over network 120 via unicast interface 217.

Synchronizer 215 may synchronize compressed video streams with their associated augmentation streams. As described above, due to the different propagation times between dedicated television networks and the internet, a compressed video stream and its associated augmentation stream may arrive at a television receiver asynchronously. Accordingly, synchronizer 215 may further encode synchronization data into the compressed video streams and/or the augmentation streams. For example, synchronizer 215 may determine an estimated delay between when the two streams will be received by television receiver 110 and encode it into the augmentation stream. Subsequently, television receiver 110 may buffer the augmentation stream based on the delay estimate. Additionally, or alternatively, synchronizer 215 may cause unicast interface 217 to transmit the augmentation stream in advance of when a corresponding point in the compressed video stream will be transmitted by broadcast interface 216.

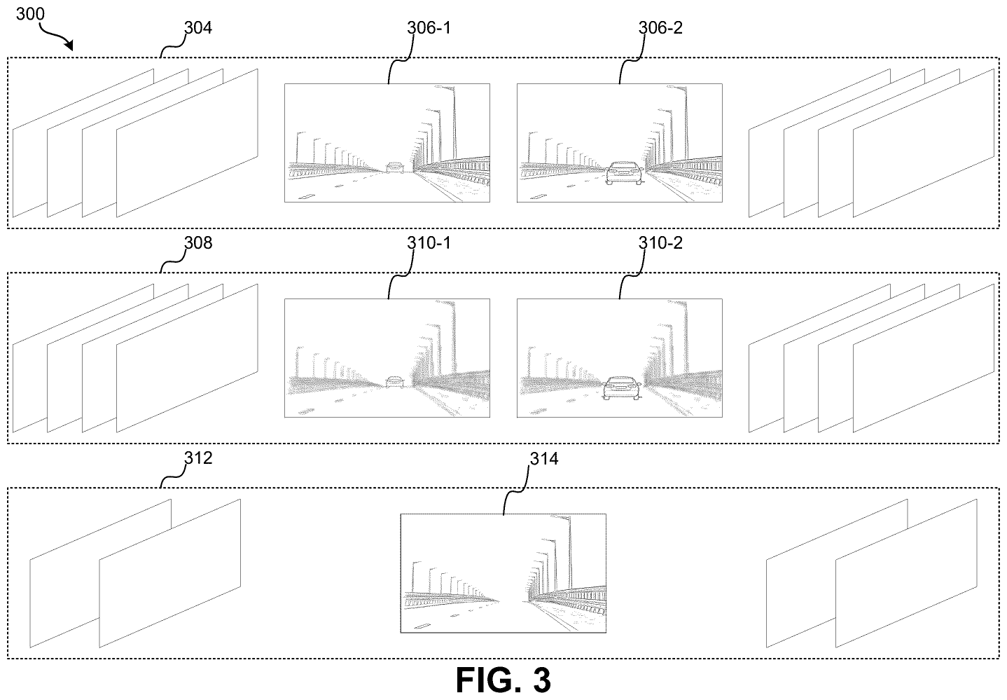

FIG. 3 illustrates exemplary streams generated by a television server system. As illustrated, original video stream 304 may represent live or prerecorded media content, such as a television show or movie. As further illustrated, original video stream 304 includes a stream of video frames 306. For example, video frames 306 depict a car driving across a bridge toward the camera. Original video stream 304 may be received by a television server system, such as television server system 202.

As described above, original video stream 304 may be encoded and compressed into compressed video stream 308 before being transmitted over a dedicated television network. As illustrated, compressed video stream 308 includes a stream of compressed video frames 310. For example, compressed video frames 310 depict the same car driving across the bridge toward the camera as in video frames 306. However, as further illustrated, while the car is depicted with the same level of detail, the background features, such as the street lamps and bridge details, are blurry in compressed video frames 310 compared with video frames 306. The loss in detail may be as a result of the algorithms and standards used to encode and compress original video stream 304 into compressed video stream 308.

As further described above, the loss between original video stream 304 and compressed video stream 308 may be captured in augmentation stream 312 and subsequently used to enhance the quality of compressed video stream. In some embodiments, the loss between original video stream 304 and compressed video stream 308 may represent loss shared by two or more frames in compressed video stream 308. In other words, the loss may be used to enhance the quality of two or more frames in compressed video stream. For example, and as illustrated, augmentation stream 312 includes loss frame 314 depicting the background features of both of video frame 306-1 and video frame 306-2 with greater detail compared to compressed video frames 310. As further illustrated, loss frame 314 does not include the car from either of video frames 306 or compressed video frames 310 as the details of the car are different between successive frames.

While loss frame 314 is illustrated as a video frame with a higher quality compared to compressed video frames 310, it should be understood that augmentation stream 312 may not necessarily be implemented as a stream of higher quality video frames. Instead, augmentation stream 312 may represent only the lost details, or residual information, that is not included in the compressed video frames. As such, augmentation stream 312 may not be used to reconstruct original video stream 304 without compressed video stream 308. Further, while described as including lost visual information, augmentation stream may additionally, or alternatively, include other non-visual loss information, such as one or more parameters used to compress video frames 306 that could subsequently be used to recreate the missing detail in compressed video frames 310.

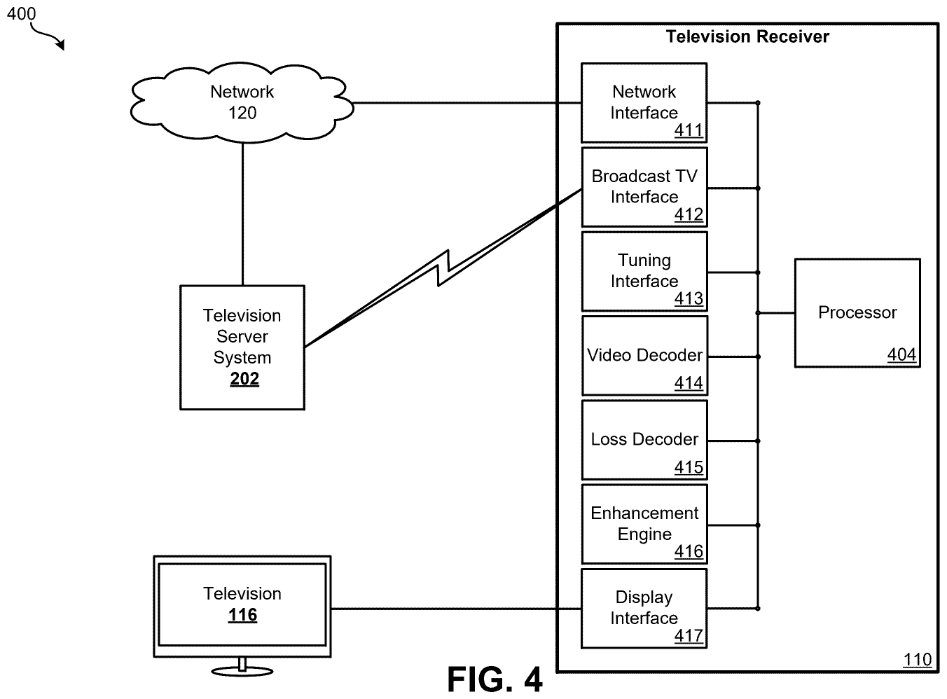

FIG. 4 illustrates an embodiment of an IP augmented television receiver within a television content delivery system 400. Television content delivery system 400 may be the same as television content delivery system 200 described above. For example, television content delivery system 400 can include television server system 202, television receiver 110, and television 116. Network 120 may function as described above.

As described above, television receiver 110 may include one or more services configured to receive digital content such as live television channels, subscription television shows, streaming movies, streaming audio, shopping, etc. from a television service provider, such as television server system 202. In some embodiments, television receiver 110 may include a plurality of services such as: network interface 411; broadcast television interface 412; tuning interface 413; video decoder 414; loss decoder 415; enhancement engine 416; and display interface 417. One or more of the services of television receiver 110 may be implemented as standalone and/or integrated software applications stored in a memory of television receiver 110. Additionally, or alternatively, one or more of the services may be implemented in hardware as a special-purpose computer, embedded system, one or more microcontrollers, one or more radios, one or more RF tuners, or the like. Television receiver 110 may also include processor 404 and one or more databases, such as a media library for storing recorded media content.

Processor 404 may be a processor or processing apparatus configured to execute executable code that performs the various functions provided by the plurality of services of television receiver 110, according to implementations described herein. The executable code may be stored in a memory (not shown) associated with processor 404.

Network interface 411 may be a wireless or a wired interface, or may have provisions for both types. For example, network interface 411 may include one or more wired outputs, such as an ethernet port, a USB port, a coaxial port, and the like. As another example, network interface 411 may include one or more antennas configured to transmit data wirelessly. Network interface 411 may additionally, or alternatively, include a network adaptor that enables television receiver 110 to transmit and receive data via one or more wired or wireless networks, such as network 120.

Broadcast television interface 412 may include one or more hardware connections configured to receive a wired connection from a broadcast television source. For example, broadcast television interface 412 may include a coaxial cable connector configured to receive RF signals from a satellite antenna or cable television lines. Broadcast television interface 412 may be configured to receive down-converted RF signals from a Low-Noise Block Converter (LNB) of a satellite dish. As described above, the RF signals may include a plurality of frequencies corresponding to television channels. Broadcast television interface 412 may also include one or more RF tuners configured to receive the RF signals and convert them into a compressed video stream representing media content for a particular television channel or media title. For example, broadcast television interface 412 may include one or more RF filters configured to tune to a particular frequency and demodulate the frequency into analog video signals representing media content.

Tuning interface 413 may receive and process requests to display television or other media content provided by television server system 202. For example, tuning interface 413 may receive television channel requests from a remote control interface, a TV guide interface and the like. In response, tuning interface 413 may transmit a tuning request to broadcast TV interface 412 to tune to a frequency corresponding to the requested media and provide the resulting compressed video stream to video decoder 414. In addition, tuning interface 413 may transmit a request for an augmentation stream corresponding to the requested media to television server system 202 via network interface 411.

Video decoder 414 may receive a compressed video stream from broadcast TV interface 412 and decode the compressed video stream into a reconstruction of an original video stream of the requested media content. As further described above, video encoder 212 may apply one or more compression algorithms to original video streams. As such, video decoder 414 may apply the inverse compression algorithms used by video encoder 212 to the compressed video stream to produce a reconstruction of the original video stream. As the compressed video stream is decoded, video decoder 414 may provide the output to enhancement engine 416.

Loss decoder 415 may receive an augmentation stream from television server system 202 via network interface 411 and decode the augmentation stream into loss data. As described above, the augmentation stream may be received in response to a tuning request transmitted to television server system 202 by tuning interface 413. As described above, the loss data may represent the lost information, or residual details from an original video stream that were omitted from the compressed video stream. Additionally, or alternatively, the loss data may represent one or more parameters used in the compression algorithms that resulted in the loss. As further described above, the augmentation stream may further include synchronization data that can be used to synchronize the loss data with the compressed video stream. As the augmentation stream is decoded, loss decoder 415 may provide the loss data to enhancement engine 416.

Enhancement engine 416 may use the loss data decoded from the augmentation stream to enhance the quality of the video stream reconstructed by video decoder 415 from a compressed video stream. As described above, each individual piece of loss data may be applicable to multiple video frames in reconstructed video stream. For example, the loss data may include additional details for similar visual features depicted in multiple successive video frames, such as a background or stationary object in each of the frames. Enhancement engine 416 may thus combine the loss data with each video frame to which it corresponds to produce an enhanced video stream.

As further described above, because the compressed video stream and the augmentation stream may each be received by television receiver 110 asynchronously, enhancement engine 416 may synchronize the reconstructed stream with the loss data before combining them to produce the enhanced video stream. For example, enhancement engine 416 may buffer the reconstructed video stream, the loss data, or both until the two sets of data are in synchrony with each other. As the enhanced video stream is produced, enhancement engine 416 may provide the enhanced video stream to display interface 417.

Display interface 417 may receive the reconstructed video stream, the enhanced video stream, or both and transmit either to television 116 for display thereon. In some embodiments, display interface determines whether the enhanced video stream is available for a corresponding reconstructed video stream. In the event that the enhanced video stream is unavailable, display interface 417 may default to providing the reconstructed video stream to television 116 for display. In this way, the requested content may still be presented when the augmentation stream has not yet been received or when the augmentation stream is no longer available (e.g., due to network speeds, bandwidth, and the like).

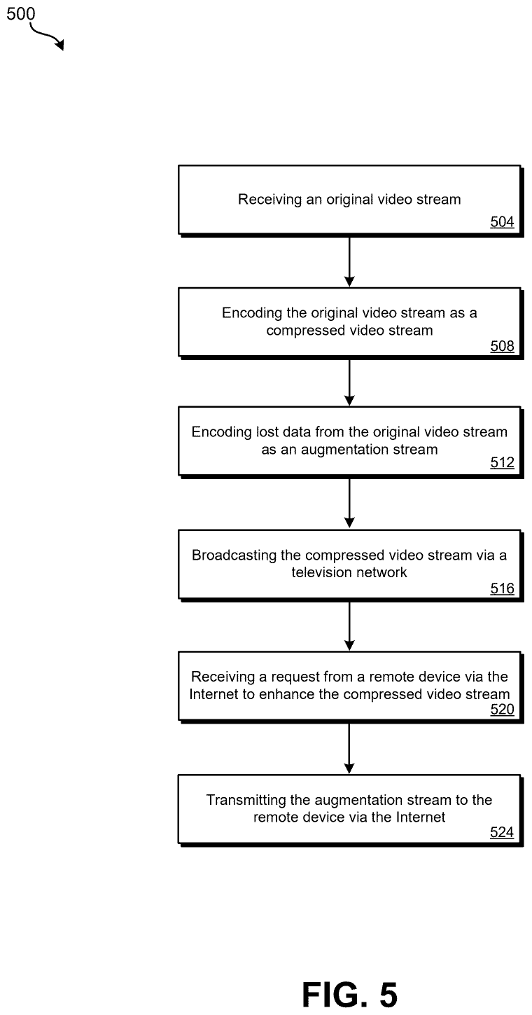

Various methods may be performed using the systems and arrangements detailed in relation to FIGS. 1-4. FIG. 5 illustrates an embodiment of a method for generating IP augmented television streams. Method 500 may be performed by a television service server system, such as satellite television server system 102 and/or television server system 202 as described above. Additionally, some blocks of method 500 may be performed at or by a remote device, such as a television receiver, smart television, OTT device, and the like, as described above in relation to television receiver 110.

Method 500 may include, at block 504, receiving an original video stream. The original video stream may be a live stream containing video and audio data associated with a particular source of media, such as a television channel, a live-stream video, or the like. Additionally, or alternatively, the original video stream may be a media file stored in one or more databases. The original video stream may represent media content captured in a first frame rate, resolution, fidelity, or the like, representing the overall visual or audio quality. In some embodiments, the quality of the original video stream is the highest quality version of the media content. The original video stream may be received from a content distributor or producer, such as network television station, movie studio, or the like. As described above, the original video stream may be received by a television service provider, such as at a server system operated by the television service provider.

At block 508, the original video stream is encoded as a compressed video stream. As described above, the original video stream may be encoded as a compressed video stream to meet bandwidth and data transmission constraints associated with the television service's primary distribution network, such as a satellite or cable distribution network. One or more compression algorithms may be applied to the original video streams to meet the constraints. Applying the compression algorithms to the original content may result in a compressed video stream that has an inherent loss when decoded to reconstruct the original video stream. For example, the compressed video stream may lose high-frequency details in the original video, such as fine textures, intricate patterns, and sharp edges can be lost or blurred. In some embodiments, the loss may be identified or generated as a separate enhancement stream concurrently with encoding the compressed video stream. For example, one or more SVC standards or protocols may be used to encode the compressed video stream, representing a base layer quality, and one or more enhancement streams representing residual information, or lost data, not contained in the compressed video stream. When received and decoded, the compressed video stream may be reconstructed into a lower quality version of the original video stream and, when combined with the one or more enhancement streams, an improved quality version of the original video stream may be produced.

At block 512, the lost data from the original video stream is encoded as an augmentation stream. As described above, the lost data may be generated and/or identified concurrently with encoding the compressed video stream. Additionally, or alternatively, the lost data from the original video stream may be identified based on a subsequent analysis of the original video stream and the compressed video stream. For example, the difference between the two streams may be identified. The loss, or residual data, may then be encoded into an augmentation stream. Additionally, or alternatively, the augmentation stream may include one or more parameters used to encode the compressed video. For example, compression parameters that would not be required to decode the compressed video stream could be included in the augmentation stream. As further described above, data in the augmentation stream may be applicable to multiple frames represented in the compressed video stream. For example, a frame in the augmentation stream may encode the loss from multiple frames in the original video stream. As another example, a packet in the augmentation stream may include one or more compression parameters used to compress multiple frames in the original video stream. By representing the residual loss and/or by creating a one-to-many relationship between the augmentation stream and the compressed video stream, the overall amount of data needed to be transmitted to enhance the compressed video stream may be further reduced. Additionally, or alternatively, by creating a one-to-many relationship, the complexity associated with synchronizing each stream may be reduced.

At block 516, the compressed video stream is broadcast via a television network. The compressed video stream may be broadcast to a plurality of television receivers connected to, or otherwise configured to receive, broadcast communications from the television network. For example, the compressed video stream may be broadcast via a satellite downlink to a plurality of satellite antennas within a geographic region covered by one or more satellites. As another example, the compressed video stream may be broadcast via a cable television network. The compressed video stream may be broadcast in one or more carrier frequencies with a plurality of compressed video streams each corresponding to a different source of media content, such as different television channels, different on-demand content, or the like. Once received, the compressed video stream may be isolated and demodulated by one or more television receivers.

At block 520, a request to enhance the compressed video stream is received from a remote device via the Internet. As described above, the remote device may be a television receiver configured to receive the broadcast transmission of the compressed video stream. For example, in response to a tuning request for a particular television channel, a television receiver may cause a tuner to isolate the compressed video stream from a plurality of compressed video streams broadcast over the television network from the television server system. In further response to the tuning request, the television receiver may transmit a request to enhance the compressed video stream to the television server system via the Internet. The request may include an identification of the requested television channel.

At block 524, the augmentation stream is transmitted to the remote device via the Internet. The augmentation stream may be transmitted to the remote device in response to receiving the request to enhance the compressed video stream. For example, in response to a request to enhance content for a particular television channel, the server system may identify the compressed video stream of the particular channel and the corresponding augmentation stream and begin transmitting the augmentation stream to the television receiver that transmitted the request. The server system may determine the address where the augmentation stream is to be sent based on an address associated with the request.

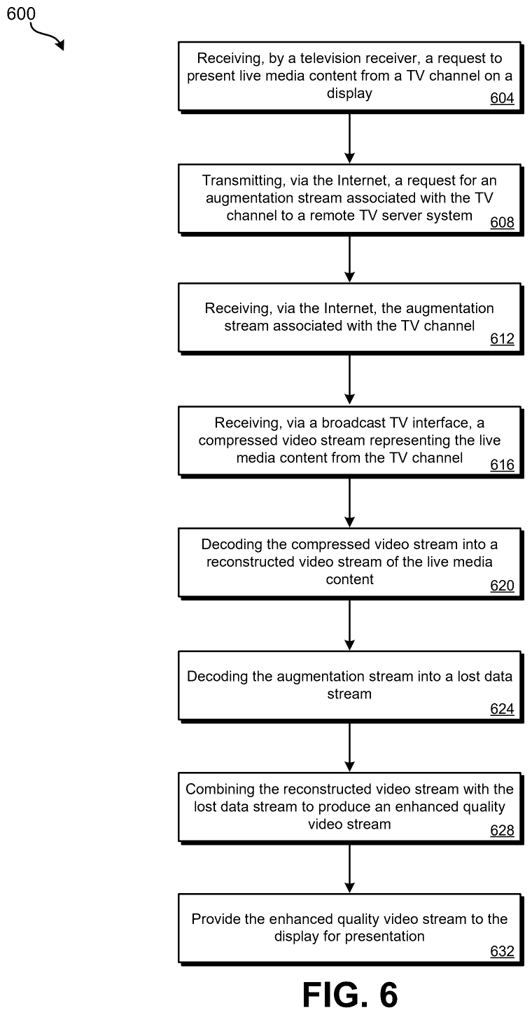

FIG. 6 illustrates an embodiment of a method for displaying IP augmented television streams. Method 600 may be performed by a remote device, such as a television receiver, smart television, OTT device, and the like, as described above in relation to television receiver 110. Additionally, some blocks of method 600 may be performed at or by a television service server system, such as satellite television server system 102 and/or television server system 202 as described above.

Method 600 may include, at block 604, receiving a request to present live media content from a television channel on a display. The request may be received by a television receiver, such as television receiver 110 described above. For example, the television receiver may receive a request from a remote control device to tune to a new or different channel. Additionally, or alternatively, the television receiver may receive a selection of a television channel from a list of television channels presented in a user interface on the display.

At block 608, a request for an augmentation stream associated with the television channel is transmitted via the Internet to a remote television server system. Based on the request to present the live media content from a particular television channel, the television receiver may transmit the request for the augmentation stream. As further described above, the augmentation stream may allow the television receiver to enhance a quality of live media content from the television channel. In some embodiments, the request includes an identification of the particular television channel, a media content title from the television channel, or the like. The request may further include identifying information for the television receiver, such as a make, a model, a serial number, a MAC address, a LAN address associated with the television receiver, a WAN address associated with a local gateway, or the like.

At block 612, the augmentation stream associated with the television channel is received via the internet. The augmentation stream may be received from the television server system in response to the request at block 608. For example, as described above in reference to method 500, after receiving the request from the television receiver, the television server system may identify the augmentation stream associated with the requested television channel and begin streaming the augmentation stream to the television receiver over the Internet. The augmentation stream may be transmitted in advance of a corresponding compressed video stream. For example, the augmentation stream may be transmitted such that, as data in the augmentation stream is transmitted, corresponding data in the compressed video stream will broadcast after a predefined amount of time.

At block 616, a compressed video stream representing the live media content from the television channel is received via a broadcast television interface. For example, as described above, a tuning interface of the television receiver may receive RF signals that represent a plurality of transponder streams corresponding to different television channels. In response to the request to present live media content from a particular television channel, the television receiver may cause the tuning interface to isolate a particular channel or frequency corresponding to the television channel and convert the analog signal into the compressed video stream.

At block 620, the compressed video stream is decoded into a reconstructed video stream of the live media content. The compressed video stream may represent an encoded and compressed version of an original video stream of the live media content. To reconstruct the live media content, the one or more algorithms and/or standards used to encode and compress the original video stream may be applied in reverse to decode and decompress the compressed video stream into a reconstruction of the original video stream. Depending on the algorithms used to compress the original video stream, the reconstructed video stream may not include information or data included in the original video stream. As such, the reconstruction of the live media content from the compressed video stream may represent a lower quality video stream compared to the original video stream.

At block 624, the augmentation stream is decoded into a lost data stream. As further described above, the augmentation stream may represent and/or include loss data from the original video stream that is not included in the compressed video stream or the reconstructed video stream. For example, the augmentation stream may include residual data from the original video stream that was lost during encoding and compression. As another example, the augmentation stream may include encoding and compression parameters used to encode and compress the original video stream and from which the lost data may be reproduced, inferred, or predicted. The data in the augmentation stream may have a one-to-many relationship with the data in the reconstructed video stream. In other words, a frame or packet in the augmentation stream may be usable to enhance the quality of multiple frames or packets in the reconstructed video stream.

At block 628, the reconstructed video stream is combined with the lost data stream to produce an enhanced quality video stream. Combining the reconstructed video stream with the lost data stream may include generating a new stream of data from the combined streams or modifying the reconstructed video stream with the lost data. In some embodiments, the two streams are synchronized before they are combined. For example, based on synchronization data in the augmentation stream, the television receiver may buffer the lost data until corresponding data in the compressed video stream has been received and decoded.

At block 632, the enhanced quality video stream is provided to the display for presentation. The enhanced quality video stream may be provided to the display via one or more wired or wireless communication channels. For example, the enhanced quality video stream may be transmitted wireless over a LAN connection to the display for presentation. Additionally, or alternatively, the enhanced quality video stream may be output by a wired connection, such as an HDMI cable, to the display. In some embodiments, the enhanced quality video stream is provided as a supplement to the reconstructed video stream. For example, the reconstructed video stream may be provided as a base layer stream and the enhanced quality video stream is provided as an alternative or enhancement layer stream. In this way, the live media content can remain viewable when the enhancement layer stream is unavailable due to network delays, lost packets, or the like.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method of augmenting satellite television streams, the method comprising:
receiving, by a satellite television server system, an original video stream;
encoding, by the satellite television server system, the original video stream as a compressed video stream, wherein encoding the original video stream results in lost data from the original video stream;
encoding, by the satellite television server system, the lost data from the original video stream as an augmentation video stream;
broadcasting, by the satellite television server system, the compressed video stream via a satellite television network;
receiving, by the satellite television server system, a request from a remote device via the Internet to enhance the compressed video stream with the augmentation video stream; and
transmitting, by the satellite television server system, and in response to the request, the augmentation video stream to the remote device via the Internet.

2. The method of augmenting satellite television streams of claim 1, wherein the augmentation video stream is further encoded with synchronization data that can be used to synchronize the augmentation video stream with the compressed video stream.

3. The method of augmenting satellite television streams of claim 2, wherein the synchronization data comprises a time delay estimate between when the remote device will receive the augmentation video stream and when the remote device will receive the compressed video stream.

4. The method of augmenting satellite television streams of claim 3, wherein the compressed video stream is broadcast on a delay compared to the transmission of the augmentation video stream, and the time delay estimate is based on the delay between the compressed video stream broadcast and the augmentation video stream transmission.

5. The method of augmenting satellite television streams of claim 2, wherein the augmentation video stream comprises a stream of reconstruction packets, the compressed video stream comprises a stream of frames, and the synchronization data for each reconstruction packet comprises a timestamp representing an estimated time when a frame that corresponds to the reconstruction packet will be received by the remote device.

6. The method of augmenting satellite television streams of claim 1, wherein the augmentation video stream comprises a stream of reconstruction packets, the compressed video stream comprises a stream of compressed video frames, and each reconstruction packet corresponds to two or more sequential compressed video frames.

7. The method of augmenting satellite television streams of claim 6, wherein encoding the lost data from the original video stream comprises:
determining, for successive sets of two or more compressed video frames, a loss factor from which at least a portion of the lost data for each of the two or more compressed video frames can be reconstructed when the loss factor is decoded; and
encoding, for each successive set of two or more compressed video frames, the loss factor in a corresponding reconstruction packet.

8. The method of augmenting satellite television streams of claim 7, wherein each successive set of two or more compressed video frames overlap with a preceding set and a succeeding set by at least one compressed video frame.

9. The method of augmenting satellite television streams of claim 7, wherein each successive set of two or more compressed video frames are contiguous with a preceding set and a succeeding set.

10. The method of augmenting satellite television streams of claim 7, wherein encoding the original video stream as the compressed video stream comprises applying one or more compression parameters to each original video frame of the original video stream, and the loss factor for each successive set of two or more compressed video frames is based at least in part on the one or more compression parameters applied to the corresponding original video frames.

11. The method of augmenting satellite television streams of claim 7, wherein the loss factor for each successive set of two or more compressed video frames is based on similar lost data in each of the two or more compressed video frames.

12. A television receiver comprising:
a broadcast television interface that receives a plurality of television channels from a dedicated television network;
a network interface that accesses the Internet;
one or more processors; and
a non-transitory computer readable storage medium storing instructions which, when executed by the one or more processors, cause the one or more processors to:
receive a request to provide live media content from a first television channel of the plurality of television channels to a display device for presentation;
transmit, via the network interface, a request for an augmentation video stream associated with the first television channel to a remote television server system;
receive, via the network interface, and from the remote television server system, the augmentation video stream associated with the first television channel;
receive, via the broadcast television interface, a compressed video stream representing the live media content from the first television channel;
decode the compressed video stream into a reconstructed video stream of the live media content;
decode the augmentation video stream into a lost data stream that represents lost data from an original stream of the live media content that is not included in the reconstructed video stream;
combine the reconstructed video stream with the lost data stream to produce an enhanced quality video stream; and
provide the enhanced quality video stream to the display device for presentation.

13. The television receiver of claim 12, wherein the dedicated television network is a satellite television network and the broadcast television interface comprises a satellite antenna interface and one or more RF tuners.

14. The television receiver of claim 12, wherein decoding the augmentation video stream further comprises decoding synchronization data from the augmentation video stream, and the instructions further cause the one or more processors to:
synchronize the reconstructed video stream with the lost data stream before they are combined.

15. The television receiver of claim 14, wherein the synchronization data comprises a time delay factor representing an estimated delay between when a reconstruction packet of the augmentation video stream is received by the network interface and when a corresponding compressed video frame in the compressed video stream is received by the broadcast television interface, and wherein the instructions further cause the one or more processors to:
wait to combine the lost data from the reconstruction packet with a reconstructed video frame until a predefined amount of time based on the time delay factor has elapsed since receiving the reconstruction packet.
